(19) United States
(12) Patent Application Publication
(10) Pub. No.: US 2005/0235908 A1
(43) Pub. Date: Oct. 27, 2005

(54) Ice painting device

(76) Inventor: David Loverock, Aurora (CA)

Correspondence Address: BERESKIN AND PARR, 40 KING STREET WEST, BOX 401, TORONTO, ON, M5H 3Y2, CA

(21) Appl. No.: 10/829,158

(22) Filed: Apr. 22, 2004

(51) Int. Cl. B05B 1/28; B05C 11/00

(52) U.S. Cl. 118/264; 118/268; 401/203

(57) ABSTRACT

An ice painting device is provided for use with a source of paint for painting an ice surface. The source of paint includes a source outlet and a closeable valve for selectively closing a flow of paint from the source outlet. The painting device includes a wand for holding by an operator. The painting device further includes a conduit system associated with the wand for transporting the paint. The conduit system defines a passage having a passage inlet and a passage outlet. The passage inlet is fluidically connectable to the source outlet. The conduit system is configured to provide fluid flow characteristics selected so that when the valve is closed, paint is substantially prevented from flowing through the passage outlet. The conduit system is configured to have fluid flow characteristics that are selected so that when the valve is closed paint is substantially prevented from flowing through the passage outlet. The painting device further includes a pad that is positionable immediately downstream from the passage outlet. The pad is configured to receive paint from the passage outlet. The pad has an ice contact face for distributing paint onto the ice surface.

### FIELD OF THE INVENTION

This invention relates to a device for painting ice, such as for painting the surface of a hockey rink.

### BACKGROUND OF THE INVENTION

Hockey rinks are typically provided with several markings on the rink surface. Such markings include blue lines to denote a particular teams end, a goal line, a red line at center ice and several face-off circles.

In the past, several systems have been proposed and used to paint the markings on the ice. One such device includes a roller that rolls on the ice and which receives paint from holes in a header pipe positioned above the roller. The header receives paint from a liquid tank. The system includes a valve for shutting off the flow of paint from the liquid tank. In general, the system is relatively complex, and presents many components that are relatively difficult to access for clean-out purposes during a changeover to a new color.

Furthermore, the roller device is relatively difficult to changeover for painting lines of different widths.

Other devices have also been used for painting rink surfaces, including spraying devices, however, these devices are prone to spilling or dripping paint even after the paint flow to the spray head is shut off, thereby necessitating cleaning of the rink surface where paint was inadvertently spilled or dripped.

Accordingly, a need exists for an improved ice painting device.

### SUMMARY OF THE INVENTION

In a first aspect the invention is directed to an ice painting device for use with a source of paint for painting an ice surface. The source of paint includes a source outlet and a closeable valve for selectively closing a flow of paint from the source outlet. The painting device includes a wand for holding by an operator. The painting device further includes a conduit system associated with the wand for transporting the paint. The conduit system defines a passage having a passage inlet and a passage outlet. The passage inlet is fluidically connectable to the source outlet. The conduit system is configured to provide fluid flow characteristics selected so that when the valve is closed, paint is substantially prevented from flowing through the passage outlet. The conduit system is configured to have fluid flow characteristics that are selected so that when the valve is closed paint is substantially prevented from flowing through the passage outlet. The painting device further includes a pad that is positionable immediately downstream from the passage outlet. The pad is configured to receive paint from the passage outlet. The pad has an ice contact face for distributing paint onto the ice surface.

In a second aspect the invention is directed to a painting device for painting an ice surface. The device includes a container for holding paint to paint the ice surface. The container has a container outlet. The device further includes a wand for holding by an operator. The device further includes a conduit system associated with the wand for transporting the paint. The conduit system defines a passage having a passage inlet and a passage outlet. The passage inlet is fluidically connectable to the container outlet. The device further includes a valve positioned in the conduit system upstream from the passage outlet. The valve is selectively closeable to prevent a flow of paint therepast. The device further includes a pad positionable immediately downstream from the passage outlet. The pad is configured to receive paint from the passage outlet. The pad has an ice contact face for distributing paint onto the ice surface. The portion of the conduit system that is downstream from the valve is configured to have fluid flow characteristics selected so that when the valve is closed paint is substantially prevented from flowing through the passage outlet.

In a third aspect, the invention is directed to an assembly for use with a painting device for marking an ice surface. The painting device includes a container, a body portion, a hose and a valve. The container is for holding paint to paint an ice surface. The container has a container outlet. The body portion is for holding by an operator. The hose is connected downstream of the container outlet and wherein the hose is connected to the body portion. The valve is positioned in the first passage portion. The valve is selectively closeable to prevent a flow of paint therepast. The assembly includes a painting head and a pad. The painting head defines a chamber. The painting head is removably connectable to the body portion such that the chamber is downstream from the hose. The chamber has an outlet. The pad is removably connectable to the painting head immediately downstream from the outlet. The pad is configured to receive paint from the outlet. The pad has an ice contact face for distributing paint onto the ice surface.

### DESCRIPTION OF THE DRAWINGS

For a better understanding of the present invention and to show more clearly how it may be carried into effect, reference will now be made by way of example to the accompanying drawings, in which:

FIG. 1 is a sectional side view of an ice painting device in accordance with a first embodiment of the present invention, in an in-use position on an ice surface;

FIG. 2 is an exploded sectional side view of the ice painting device shown in FIG. 1; and

FIG. 3 is a front view of a plurality of painting heads for use as part of the ice painting device shown in FIG. 1.

### DESCRIPTION OF THE PREFERRED EMBODIMENTS

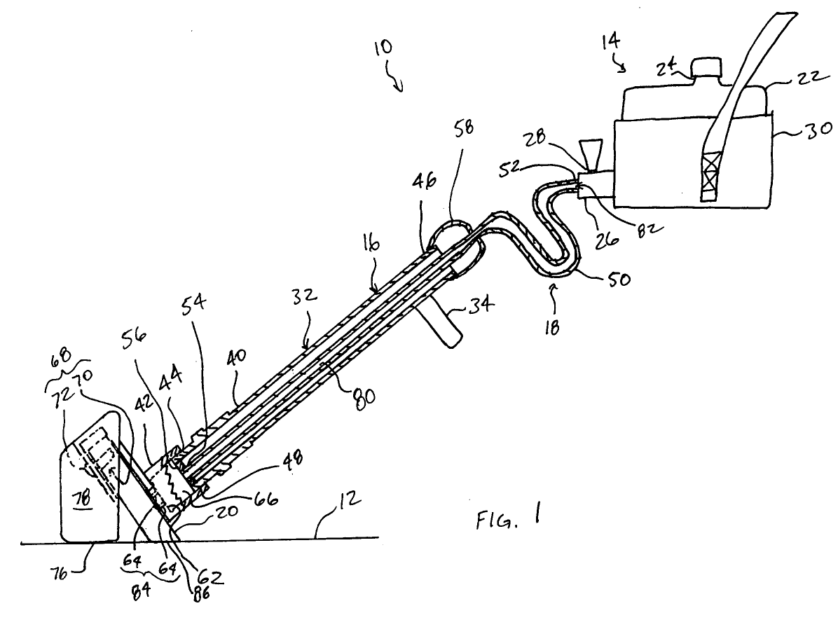

Reference is made to FIG. 1, which shows an ice painting device 10 in accordance with a first embodiment of the present invention for use in painting an ice surface 12. The ice painting device 10 is configured to facilitate clean-out thereby facilitating changeover to another paint colour. Furthermore, the device 10 incorporates relatively few parts, thereby simplifying maintenance required for the device 10. Furthermore, the device 10 has a reduced tendency to drip or spill paint once paint flow has been shut off. This facilitates transporting the device after painting a region of ice without dripping paint en route.

The device 10 includes a source 14 of paint, a wand 16, a conduit system 18 and a pad 20. The source 14 of paint includes a container 22, which may be a polymeric jug of any desired capacity, such as 5 litres. The source 14 has an inlet 24 for receiving paint, which is preferably at the top of the container 22. A source outlet 26 is preferably positioned proximate the bottom of the container 22. The outlet 26 may be positioned along the bottom surface of the container 22, or more preferably is positioned at the bottom of a sidewall of the container 22.

A valve 28 may be positioned adjacent the outlet 26. The valve 28 may be a simple manually operated polymeric ball valve, such as is commonly used with polymeric jugs with bottom outlets.

The container 22 may include a carrying case 30 with a shoulder strap to facilitate carrying the container 22 on the shoulder of an operator while painting the ice 12.

The wand 16 transfers paint from the source 14 to the ice 12. The wand 16 includes a body 32 with a handle 34. The body 32 holds the conduit system 18 and the pad 20.

The wand body 32 may include a first portion 40 and a second portion 42, which may be removably connected to each other by any suitable means, such as a threaded connection 44. The first portion 40 may be hollow and may include a first end 46 and a second end 48. A hose 50 having an upstream end 52 and a downstream end 54 may pass through the first portion 40. The hose 50 may extend out from the first end 46 of the first body portion 40 for connection to the source 14 of paint. The downstream end 54 of the hose 50 may be retained at the second end 48 of the first body portion 40 by a holding means 56. The holding means 56 may be any suitable means for holding the hose end 54, such as a polymeric disc that fits into the second end 48, and which has an aperture for receiving and frictionally holding the hose end 54. Epoxy or another fastening means may be further added to assist in retaining the hose end 54 in place. The holding means 56 may itself be attached to the first body portion 40 in any suitable way, such as by epoxy.

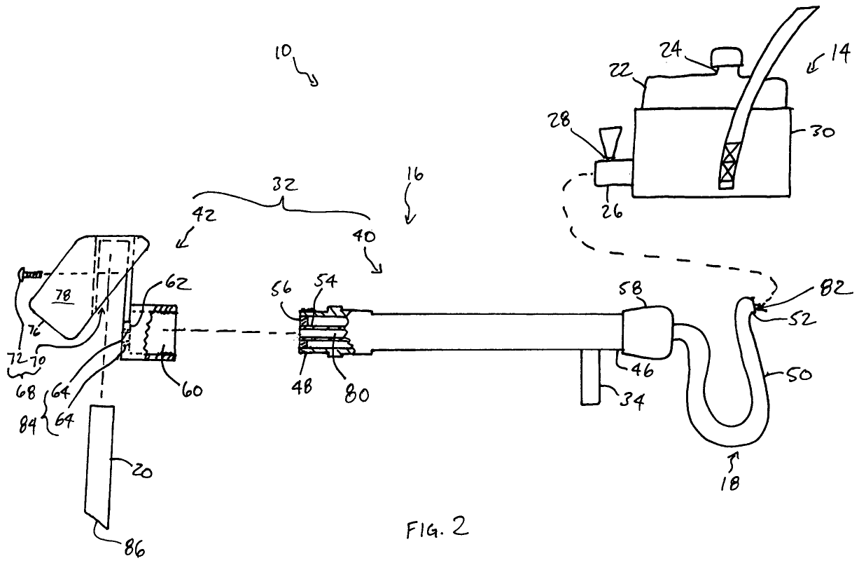

In the embodiment shown in FIGS. 1 and 2, the holding means 56 is a wetted part, in the sense that it may be in contact with marking fluid during use of the device 10. Accordingly, the holding means 56 sealingly connects with the hose 50 and with the first body portion 40 to prevent leakage of paint therepast into the interior of the first body portion 40.

A closure 58 may be fitted over the first end 46 of the first body portion 40. The closure 58 includes an aperture therethrough to permit the hose 50 to extend therethrough.

The second body portion 42, which may also be referred to as a painting head 42, includes an open chamber 60 (see FIG. 2) having a bottom wall 62 with at least one, and preferably two or more outlet apertures 64 therethrough. The outlet apertures 64 transfer paint from the chamber 60 to the pad 20 that is positioned immediately downstream from the apertures 64. Providing a greater number of apertures 64 that are spaced apart from each other improves the distribution of paint in the pad 20, relative to providing fewer apertures.

The second body portion 42 connects with the first body portion 40 so as to define a closed chamber 66 between the second end 48 of the first body portion 40 and the open chamber 60 of the second body portion 42. The downstream end 54 of the hose 50 empties into the chamber 66 and is thus fluidically immediately upstream of the chamber 66. During cleaning of the wand 16, the first and second body portions 40 and 42 may be separated to permit cleaning of the chamber 60 and the second end of the first body portion 40. The surfaces that define the chamber 66 are all preferably configured for easy cleaning to reduce the likelihood of paint being inadvertently retained therein during a changeover to a new colour.

The second body portion 42 further includes a holding means 68 for holding the pad 20. The holding means 68 may include, for example, a slot 70, which receives the pad 20. One or more fasteners 72 may be mounted in the second body portion 42 and at least partially through the pad 20 to hold the pad 20 in the slot 70. A portion of the pad 20 extends outwards from the slot 70, so that it is exposed for contacting and marking the ice 12 during use.

The second body portion 42 further includes a guide means for contacting the ice 12 and for guiding the device 10 on the ice 12. The guide means includes a pair of ice contact faces 76, which are the surfaces of the wand body 32 that contact the ice 12 during use of the device 10. The guide means may further include a vertically planar wall 78 at two opposing sides of the device 10. The walls 78 permit the device 10 to be positioned alongside a wall (not shown) or other vertical surface to guide the device 10 during its travel on the ice surface 12.

In the embodiment shown in FIGS. 1 and 2, the conduit system 18 includes the hose 50 and the chamber 66, which together define a passage 80 for the paint. The upstream end 52 of the hose 50 provides a passage inlet 82 and the chamber outlet apertures 64 constitute a passage outlet 84.

The conduit system 18 may be configured so that gravity flow of the paint occurs when the valve 28 is open. Alternatively, the conduit system 18 may be configured so that a pump (not shown) is required to cause paint flow therethrough.

When the valve 28 is closed, the valve 28 prevents paint flow therepast from the container 22 into the conduit system 18. The conduit system 18 itself may be further configured to provide fluid flow characteristics that are selected so that when the valve 28 is closed, paint is substantially prevented from flowing through the outlet apertures 64, which are downstream from the valve 28, into the pad 20. When the valve 28 is closed there is little or no air pressure acting in a downstream direction on the paint that is downstream from the valve 28. Air pressure continues to act however, in the upstream direction on the paint at the chamber outlet apertures 64 by virtue of air that passes through the pad 20 itself and contacts the paint at the outlet apertures 64. The conduit system 18 may be configured so that, when the valve 28 is closed, the net air pressure force in the upstream direction is sufficient to prevent paint flow from the chamber outlet apertures 64 into the pad 20.

An aspect of preventing paint from flowing from the conduit system 18 when the valve 28 is closed involves preventing air from flowing upwards into the conduit system 18. In particular, the outlet apertures 64 themselves may be made sufficiently small in cross-sectional area to prevent air from passing upwards through the paint retained therein. Preventing air from flowing upwards through the conduit system 18, in turn prevents an air pocket from building up at some position upstream from the outlets 64. Such an air pocket would ultimately act with some amount of pressure in a downstream direction on the paint downstream from it, thereby counteracting the upstream air pressure force helping to retain the paint in the conduit system 18 when the valve 28 is closed.

The pad 20 is held on the second body portion 42 in abutment with the chamber outlet apertures 64, to capture the paint that flows from the outlet apertures 64. The pad 20 may have an angled edge face 86. The edge face 86 may be configured to have a suitable angle to flatly contact the ice surface 12 when the device 10 is held at an operating angle by an operator during use.

The pad 20 may be made from a fibrous material, such as from polymeric fibres. The fibres may a plurality of randomly oriented be attached to one another by thermal bonding or by any other suitable means. The pad 20 may have a relatively open structure to provide a relatively low resistance to paint flow therethrough from the outlet apertures 64 to the ice-contact face 86. The open structure of the pad 20 also provides for a small contact surface area between the ice-contact face 86 and the ice 12, relative to the overall footprint of the ice-contact face 86 on the ice 12. Providing a relatively small contact surface area relative to the footprint of the ice-contact face 86 permits a relatively wide line to be painted, while reducing the risk of the pad sticking to the ice 12 in the event it remains stationary on the ice 12 for a period of time.

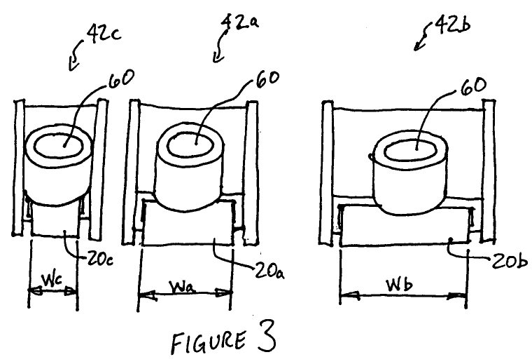

Reference is made to FIG. 3. In order to permit the painting device to paint lines of a variety of different widths, a plurality of heads 42 may be provided, each configured for holding a pad 20 of a different width. For example, three heads 42a, 42b and 42c may be provided, which are interchangeable with each other for connection to the first body portion 40 (FIG. 1). The heads 42a, 42b and 42c hold pads 20a, 20b and 20c respectively, having widths Wa, Wb and Wc respectively, for painting lines having widths Wa, Wb and Wc respectively. it will be appreciated that the device 10 (FIG. 1) may be provided with more or fewer heads 42 than the three shown in FIG. 3.

While using a relatively open structure fibrous material for the pad 20 is advantageous as described above, it is alternatively possible, however, to use other materials for the pad 20, however, such as, for example, a sponge material.

Because of its simple nature, the device 10 is relatively easy to clean. For example, to carry out a changeover to a new colour of paint, the hose 50 may be disconnected from the old container 22. The first and second wand body portions 40 and 42 are separated from each other, and the pad 20 is removed from the second body portion 42. For water-based paint, the hose 50 may be cleaned out, for example, by running water therethrough. The wetted surfaces at the second end 48 of the first body portion 40 and the chamber 60 and slot 70 of the second body portion 42 may be cleaned by wiping them with a wetted cloth. A new pad 20 may be connected in place in the slot 70 and held with the fasteners 72. The first and second body portions 40 and 42 may be reconnected together and the hose 50 may be connected to the new container 22.

It has been described for the valve 28 to be positioned immediately adjacent the container outlet 26. It is alternatively possible for the valve 28 to be positioned elsewhere (not shown) in the passage 80 between the container 22 and the chamber outlet apertures 64 dividing the passage 80 into an upstream portion and a downstream portion. In this case, the device 10 may be configured so that the portion of the conduit system downstream of the valve 28 may have a selected resistance to flow of paint sufficient to prevent flow of paint out of the chamber outlet apertures 64 when the valve 28 is closed.

It has been described for the device 10 to include the container 22 and the valve 28. It is contemplated that the device 10 may omit the container 22 and valve 28. For example, the device 10 may include only the wand 16, conduit system 50 and the pad 20, and the purchaser may be expected to provide their own container 22 and valve 28 since such containers may be acquired as an off-the-shelf item at a store.

It has been described for the device 10 to gravity feed paint from the container 22 to the pad 20 through the conduit system. In a gravity-fed embodiment such as is described above, care must be taken to ensure that the conduit system 18 is configured so that gravity provides sufficient force to urge the paint therethrough when the valve 28 is open. Such a consideration restricts how much the conduit system 18 can be made resistant to the flow of paint, which can impact the performance of the device 10 at resisting dripping of paint when the valve 28 is closed. It is alternatively possible for the device 10 to include a suitably sized pump (not shown), which may be manually or electrically powered to urge paint through the conduit system 32. Such a pump, if electrically powered could be powered by a battery or alternatively by a connection to an electrical outlet. Incorporating a pump in the conduit system 18 facilitates configuring the conduit system 18 to provide a high resistance to flow from the outlet apertures 64 when the valve is closed. This is because the system need not be configured to permit gravity flow when the valve is open if a pump is used. Furthermore, if the system 18 does not permit paint flow unless the pump is operating, then the valve 28 itself may not be needed, since the pump itself performs the function of the valve 28, ie. when the pump operates paint flow occurs and when the pump is not operating, paint flow does not occur.

The handle 34 on the wand 32 has been shown as a member that extends outwards from the first body portion 40. It is alternatively possible for this outwardly extending member to be omitted and for the first body portion 40 itself to act as a handle. Alternatively, the handle may be made from any other suitable member suitable for controlling and guiding the device 10.

While the above description constitutes the preferred embodiments, it will be appreciated that the present invention is susceptible to modification and change without departing from the fair meaning of the accompanying claims.

1. An ice painting device for use with a source of paint for painting an ice surface, wherein the source of paint includes a source outlet and a closeable valve for selectively closing a flow of paint from the source outlet, comprising:
a wand for holding by an operator;
a conduit system associated with the wand for transporting the paint, the conduit system defining a passage having a passage inlet and a passage outlet, wherein the passage inlet is fluidically connectable to the source outlet, wherein the conduit system is configured to provide fluid flow characteristics selected so that when the valve is closed, any paint that is in the passage downstream from the valve is substantially prevented from flowing through the passage outlet; and
a pad positionable immediately downstream from the passage outlet, wherein the pad is configured to receive paint from the passage outlet, wherein the pad has an ice contact face for distributing paint onto the ice surface.

2. A painting device as claimed in claim 1, wherein the passage outlet comprises at least one outlet aperture, each outlet aperture having a sufficiently small cross-sectional area so that when paint blocks the entirety of the cross-sectional area, air is prevented from flowing upstream into the conduit system.

3. A painting device as claimed in claim 1, wherein the conduit system is configured to permit gravity flow of paint therethrough from the source of paint when the valve is open.

4. A painting device as claimed in claim 1, wherein the pad is made of a material having an open structure.

5. A painting device as claimed in claim 1, wherein the pad is removably connectable to the wand.

6. A painting device as claimed in claim 1, wherein the wand includes a first body portion and a second body portion, which are separable from each other to expose portions of the passage.

7. A painting device as claimed in claim 6, wherein the conduit system comprises a hose having a hose inlet and a hose outlet, wherein the hose outlet communicates with a chamber defined in part by the first body portion and in part by the second body portion, and wherein the first and second body portions are separable to expose the chamber.

8. A painting device as claimed in claim 1, wherein the wand includes a first body portion and a first painting head, wherein the pad is a first pad is configured for painting a line having a first width and wherein the first pad is connected to the first painting head, and wherein the painting device further includes a second painting head wherein the second painting head is connectable with the first body portion, and wherein the second painting head has a second pad mounted thereto, wherein the second pad is configured for painting a line having a second width.

9. A painting device for painting an ice surface, comprising:
a container for holding paint to paint an ice surface, wherein the container has a container outlet;
a wand for holding by an operator;
a conduit system associated with the wand for transporting the paint, the conduit system defining a passage having a passage inlet and a passage outlet, wherein the passage inlet is fluidically connectable to the container outlet;
a valve positioned in the conduit system upstream from the passage outlet, wherein the valve is selectively closeable to prevent a flow of paint therepast; and
a pad positionable immediately downstream from the passage outlet, wherein the pad is configured to receive paint from the passage outlet, wherein the pad has an ice contact face for distributing paint onto the ice surface,
wherein the portion of the conduit system that is downstream from the valve is configured to provide fluid flow characteristics selected so that when the valve is closed, any paint that is in the passage downstream from the valve is substantially prevented from flowing through the passage outlet.

10. A painting device as claimed in claim 9, wherein the passage outlet comprises at least one outlet aperture, each outlet aperture having a sufficiently small cross-sectional area so that when paint blocks the entirety of the cross-sectional area, air is prevented from flowing upstream into the conduit system.

11. A painting device as claimed in claim 9, wherein the conduit system is configured to permit gravity flow of paint therethrough from the source of paint when the valve is open.

12. A painting device as claimed in claim 9, wherein the valve is connected to the container outlet.

13. A painting device as claimed in claim 9, wherein the pad is made of a material having an open structure.

14. A painting device as claimed in claim 9, wherein the pad is removably connectable to the wand.

15. A painting device as claimed in claim 9, wherein the wand includes a first body portion and a second body portion, which are separable from each other to expose portions of the passage.

16. A painting device as claimed in claim 15, wherein the conduit system comprises a hose having a hose inlet and a hose outlet, wherein the hose outlet communicates with a chamber defined in part by the first body portion and in part by the second body portion, and wherein the first and second body portions are separable to expose the chamber.

17. A painting device as claimed in claim 9, wherein the wand includes a first body portion and a first painting head, wherein the pad is a first pad is configured for painting a line having a first width and wherein the first pad is connected to the first painting head, and wherein the painting device further includes a second painting head wherein the second painting head is connectable with the first body portion, and wherein the second painting head has a second pad mounted thereto, wherein the second pad is configured for painting a line having a second width.

18. (canceled)

19. A painting device as claimed in claim 21, wherein each of the first and second pads is made of a material having an open structure.

20. A painting device as claimed in claim 19, wherein each of the first and second pads is made of a fibrous material.

21. An ice painting device for use with a source of paint for painting an ice surface, wherein the source of paint includes a source outlet and a closeable valve for selectively closing a flow of paint from the source outlet, comprising:
a wand for holding by an operator, wherein the wand includes a first body portion, a first painting head and a second painting head, wherein the first painting head has a first pad mounted thereto, and wherein the second painting head has a second painting head mounted thereto;
a conduit system associated with the wand for transporting the paint, the conduit system defining a passage having a passage inlet and a passage outlet, wherein the passage inlet is fluidically connectable to the source outlet;
and wherein the first pad is positionable immediately downstream from the passage outlet, wherein the first pad is configured to receive paint from the passage outlet, wherein the first pad has a first ice contact face for distributing paint onto the ice surface wherein the first pad is configured for painting a first line having a first width,
and wherein the second painting head is connectable with the first body portion in place of the first painting head, and wherein the second painting head has a second pad mounted thereto, wherein the second pad is configured for painting a line having a second width.
